(19) United States
(12) Patent Application Publication
(10) Pub. No.: US 2008/0104867 A1
(43) Pub. Date: May 8, 2008

(54) Color Coded Organization Tools and System

(75) Inventors: Leanne McCormack, Unadilla, NY (US); Ben Hendee, Unadilla, NY (US); Timothy B. Kesselring, Bainbridge, NY (US); Aaron Baughman, Afton, NY (US); Cynthia M. Van Tyle, Walton, NY (US)

Correspondence Address: BOND, SCHOENECK & KING, PLLC, ONE LINCOLN CENTER, SYRACUSE, NY, 13202-1355, US

(73) Assignee: MeadWestvaco Corporation, Glen Allen, VA (US)

(21) Appl. No.: 11/934,307

(22) Filed: Nov. 2, 2007

Related U.S. Application Data
(60) Provisional application No. 60/864,076, filed on Nov. 2, 2006.

(51) Int. Cl. G09D 3/00; B42D 5/04; G09F 15/00; B42F 23/00

(52) U.S. Cl. 40/107; 40/371; 40/380; 40/606.01

(57) ABSTRACT

An organization system comprising a white board system, a wall calendar, reminder notes, and a planner, all of which are commonly color coded, wherein each color is associated with an individual user of the system. The tools (i.e., the white board system, the calendar, the notes, and the planner) may be used individually or collectively as an entire organization system.

### PRIORITY CLAIM

The present application claims priority to U.S. Provisional Application Ser. No. 60/864,076, filed Nov. 2, 2006, the entirety of which is hereby incorporated by reference.

### BACKGROUND OF THE INVENTION

The present invention relates generally to organizers, and more particularly to multi-user organizers.

Organization systems generally comprise one or more types of calendars, planners, organizers, and the like. In a family or business where one or more types of organization tools are used to collectively maintain a schedule (“schedule” is used herein to generically refer to the collective types of activities or records that are generally maintained in an organizer type product, such as, for example, appointments, to do lists, reminders, and the like) of all the users of the system, it is important that the tool be used consistently so that one user's schedule is not inadvertently thought to be another user's schedule. Without a distinction between the users of the organizational system, there is a risk that it will be ineffective at performing its functions.

It is therefore a principal object and advantage of the present invention to provide a set of multi-user organizer tools that discriminate amongst the users.

It is another object and advantage of the present invention to provide a set of multi-user organizer tools that can be used individually or as a system.

Other objects and advantages of the present invention will in part be obvious, and in part appear hereinafter.

### SUMMARY OF THE INVENTION

In accordance with the foregoing objects and advantages, the present invention provides an organization system comprising a white board system, a wall calendar, reminder notes, and a planner, all of which are commonly color coded, wherein each color is associated with an individual user of the system. The tools (i.e., the white board system, the calendar, the notes, and the planner) may be used individually or collectively as an entire organization system.

### BRIEF DESCRIPTION OF THE DRAWINGS

The present invention will be more fully understood and appreciated by reading the following Detailed Description in conjunction with the accompanying drawings, in which:

FIG. 1 is a front elevation view of a white board system made in accordance with the present invention;

FIG. 2 is a side elevation view thereof;

FIG. 3 is a front elevation view of a wall calendar made in accordance with the present invention;

FIG. 4 is a front elevation view of a series of note pads made in accordance with the present invention;

FIG. 5 is a plan view spiral bound organizer made in accordance with the present invention; and

FIG. 6 is a perspective view of a plurality of storage containers.

### DETAILED DESCRIPTION

Referring now to the drawings, in which like reference numerals refer to like parts throughout, there is seen in FIGS. 1 and 2 a white board system, designated generally by reference numeral 10, comprising an organizational board 12, a plurality of folders color coded with a distinctly colored tab 14 (e.g., green, yellow, purple, beige, and blue) that is attached to one edge (e.g., the side edge) of the respective folder, and a frame 16 comprising a storage compartment and to which the board 12 is attached and the folders are housed within. Board 12 has several sections associated therewith, including a color coded calendar section 18 (with each day on the calendar being a defined space in which a message can be written that corresponds with, for example, a task or appointment that needs to be taken care of on that day, such as the “PTA Meeting” message 20 printed on the “10^{th}”. The color coding referred to herein is intended to provide a plurality of colors each of which may be associated with an individual person (e.g., Danny is green, Susan is yellow, Ann is purple, Mom is beige and Dad is blue). Therefore, each individual's schedule can be accessed on board 12 along with use of the other organizational tools described herein. Structurally, a board system such as the one disclosed in Applicant's pending United Stated patent application Ser. No. 10/759,540, filed Jan. 16, 2004, incorporated herein by reference, would suffice for achieving the basic structural purposes of the present invention, without, of course, inclusion of the functionality achieved through the inventive color coding applied to the various sections of board system 10.

A second section of each board 12 is a weekly note taking section 22, containing an area on which appointments, to do lists, and other reminder items can be written for the noted day of the week, such as the “golf” message 24 on “Saturday.” This section comprises a dry erase surface.

A third section of board system 12 is a color coded message section 26. There is one color coded message space for each color used in system 10 (e.g., green, yellow, purple, beige, and blue). A message, such as “pick up milk” message 28 written on the “green” message space will remind the individual associated with “green” to pick up milk.

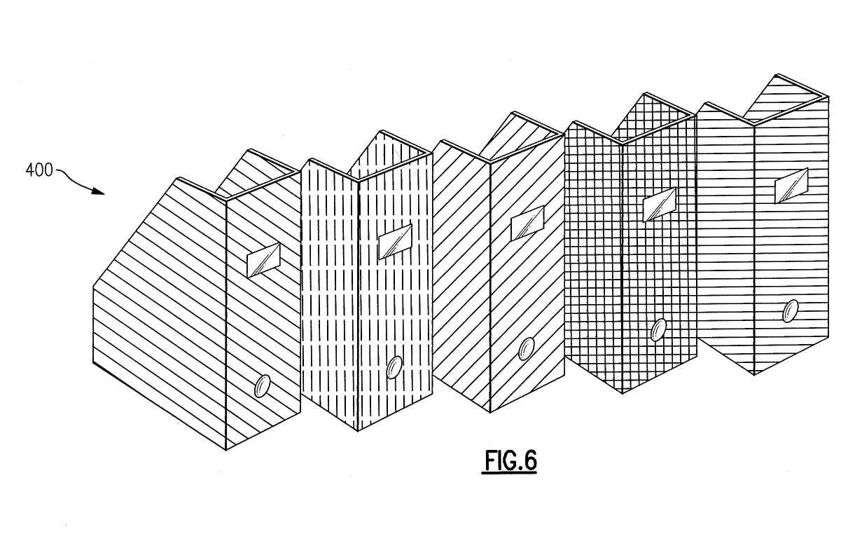

A fourth section of system 10 is a hook section 30, which comprises one color coded hook for each color included in system 10. Hooks 30 are affixed to frame 16, and can be used to hang keys or the notes from FIG. 4 on, among other things, that are associated with the individual associated with the particular color hook on which the article is hung.

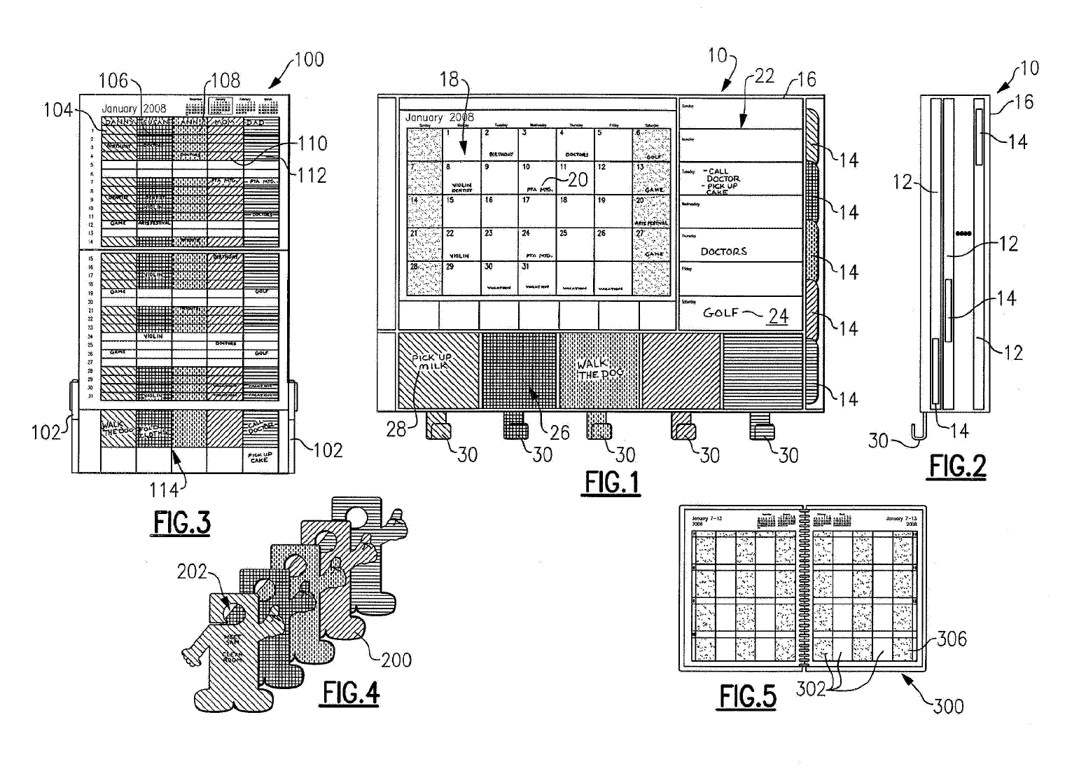

With reference to FIG. 3, a color coded wall calendar 100, monthly calendar in the embodiment shown in this figure, is provided. Calendar 100 includes a holder for a marker 102 attached thereto. Marker 102 can be used to write messages (which can then be erased) on calendar 100. Calendar 100 is divided into multiple sections 104, 106, 108, 110, and 112. In the preferred embodiment shown, the sections 104-112 are arranged vertically and in side by side relation one another. Of course, horizontal or other arrangements are possible. Each section 104-112 is further subdivided into slots that correspond with a day of the month (other time increments are of course also possible), with the day of the month written to one side of the sub-divisions. A message may then be written on a particular day and for a particular individual according to that person's color (e.g., On January 3, the message “Birthday” is written in the green column which is associated with Danny, while the message “Tryouts” is written on the 21^{st} under the purple column which is associated with Ann). Additionally, a daily reminder section 114 is included, wherein this section is adapted to receive a written communication reminding the individual associated with a particular color to do something (e.g., green (Danny) is reminded to “walk the dog”.)

With reference to FIG. 4, note members 200 in the various colors that have been described relative to board system 10 and calendar 100 are provided. Note members 200 may comprises, for example, ethylene vinyl acetate dry erase boards or a stack of adhesive backed notes (individual sheets of paper that include a strip of pressure sensitive adhesive coating a portion of the rear surface thereof.) A note may be written on note member 200 and associated with the individual to whom that color note corresponds (e.g., “Meet Sam” and “Clean Room” are written on a yellow note that is associated with Susan.) The note members 200 may be equipped with an opening 202 adjacent the top ends thereof, which opening may be slipped on a hook 30 of the white board system 10 or on a door handle, for example, or they may be adhesively placed on one of boards 12 or on calendar 100.

With reference to FIG. 5, a spiral bound (or other bound) planner 300 is provided. Planner 300 is equipped with color coded sections 302. Each page of color coded sections 302 can be delineated into time increments, such as 8 am to 8 pm on a daily basis. Monthly, weekly, or other time increment pages could also be used. Each color coded section 302 in planner 300 is used to maintain the schedule of the individual associated with the color.

With reference to FIG. 6, color coded storage containers 400 may also be used with system 10. Other organizational tools, such as undated calendars, planners and diaries could also be color coded in accordance with the present invention.

Each tool described herein, the white board system 10, the calendar 100, the reminder notes, 200, and the planner 300, can be used individually or collectively as an organizational system.

What is claimed is:

1. A multiple user organizational product, comprising:
a. an organizational board having a plurality of sections at least one of which includes indicia that uniquely associates said section with a particular one of the multiple users; and
b. a frame to which said organizational board is attached.

2. The multiple user organizational product according to claim 1, further comprising a plurality of hooks adapted for attachment to said frame, wherein each of said plurality of hooks includes the same said indicia that uniquely associates said section with a particular one of the multiple users.

3. The multiple user organizational product according to claim 1, wherein said organizational board comprises at least one of a calendar section and a note taking section.

4. The multiple user organizational product according to claim 1, wherein said organizational board comprises a plurality of message sections wherein each of said plurality of message sections includes said indicia that uniquely associates each of said sections with a particular one of the multiple users.

5. The multiple user organizational product according to claim 1, wherein said indicia comprises a plurality of distinct colors each one of which is adapted to be associated with each of the multiple users.

6. The multiple user organizational product according to claim 1, wherein said frame includes a storage compartment.

7. The multiple user organizational product according to claim 6, further comprising a plurality of folders each of which collectively incorporate said indicia so that each of said folders in uniquely associated with one of the multiple users, said folders adapted for being housed in said storage compartment.

8. A multiple user organizational system, comprising:
a. an organizational board which includes a plurality of section at least one of which includes indicia that uniquely associates said section with a particular one of the multiple users;
b. a frame to which said organizational board is connected; and
c. a plurality of note taking members each of which includes the same said indicia that uniquely associates said section with a particular one of the multiple users.

9. The multiple user organizational system of claim 8, further comprising a wall calendar comprising a plurality of demarcated sections wherein each of said demarcated sections includes the same said indicia that uniquely associates said section with a particular one of the multiple users.

10. The multiple user organizational system of claim 8, further comprising a planner comprising a plurality of pages each of which comprises a plurality of demarcated sections wherein each of said demarcated sections includes the same said indicia that uniquely associates said section with a particular one of the multiple users.

11. The multiple user organizational system according to claim 8, further comprising a plurality of hooks adapted for attachment to said frame, wherein each of said plurality of hooks includes the same said indicia that uniquely associates said section with a particular one of the multiple users.

12. The multiple user organizational system, according to claim 8, wherein said indicia comprises a unique color each one of which is adapted to be associated with each of the multiple users.

13. The multiple user organizational system according to claim 8, wherein said frame includes a storage compartment.

14. The multiple user organizational system according to claim 13, further comprising a plurality of folders each of which collectively incorporate said indicia so that each of said folders in uniquely associated with one of the multiple users, said folders adapted for being housed in said storage compartment.

15. A multiple user organizational system, comprising:
a. an organizational board which includes a plurality of section at least one of which includes indicia that uniquely associates said section with a particular one of the multiple users;
b. a frame in which each of said plurality of organizational boards are housed; and
c. a wall calendar comprising a plurality of demarcated sections wherein each of said demarcated sections includes the same said indicia that uniquely associates each of said boards with a particular one of the multiple users.

16. The multiple user organizational system of claim 15, further comprising a planner comprising a plurality of pages each of which comprises a plurality of demarcated sections wherein each of said demarcated sections includes the same said indicia that uniquely associates said section with a particular one of the multiple users.

17. A multiple user organizational system, comprising:
a. an organizational board which includes a plurality of sections at least one of which includes indicia that uniquely associates said section with a particular one of the multiple users;
b. a frame to which each of said organizational board is attached; and
c. a planner comprising a plurality of pages each of which comprises a plurality of demarcated sections wherein each of said demarcated sections includes the same said indicia that uniquely associates said section with a particular one of the multiple users.

18. A method for keeping organizing records for multiple people, comprising the steps of:
a. providing a first organizational recording product which comprises a plurality of sections at least one of which includes an indicia that uniquely associates said plurality of sections with a particular one of the multiple people; and
b. assigning each of the multiple people with a said indicia that distinctively associates each person selected from the multiple people from the other multiple people.

19. The method according to claim 18, wherein said first organizational product comprises an organizational board.

20. The method according to claim 19, further comprising the step of providing a frame to which said organizational board is connected.

21. The method according to claim 18, comprising the further step of providing a second plurality of organizational recording products each one of which includes the same said indicia that uniquely associates each of said plurality of sections with a particular one of the multiple people.

22. The method according to claim 21, wherein said second plurality of organizational recording products comprises a plurality of note taking members adapted for hanging from a hook.

23. The method according to claim 21, comprising the further step of providing a third organizational recording product that includes a plurality of demarcated sections each one of which includes the same said indicia that uniquely associates each of said first plurality of sections with a particular one of the multiple people.

24. The method according to claim 23, wherein said third organizational recording product is a calendar.

25. The method according to claim 23, comprising the further step of providing a fourth organizational recording product that includes a plurality of demarcated sections each one of which includes that same said indicia that uniquely associates each of said first plurality of sections with a particular one of the multiple people.
